(19) United States
(12) Patent Application Publication
(10) Pub. No.: US 2024/0047700 A1
(43) Pub. Date: Feb. 8, 2024

(54) CATALYST

(71) Applicant: TOYOTA JIDOSHA KABUSHIKI KAISHA, Toyota-shi (JP)

(72) Inventor: Keiichi OKUBO, Toyota-shi (JP)

(73) Assignee: TOYOTA JIDOSHA KABUSHIKI KAISHA, Toyota-shi (JP)

(21) Appl. No.: 18/357,983

(22) Filed: Jul. 24, 2023

(30) Foreign Application Priority Data
Jul. 26, 2022 (JP) 2022-118337

(51) Int. Cl. H01M 4/86; H01M 4/92

(52) U.S. Cl. CPC H01M 4/8663; H01M 4/926; H01M 4/8668

(57) ABSTRACT

A catalyst containing an organic nitrogen compound and capable of improving catalyst performance. A catalyst, wherein the catalyst comprises metal particles having oxygen reduction activity, an additive and a binder; wherein the additive is at least one organic nitrogen compound; wherein the organic nitrogen compound is a monomer represented by the general formula (1) or a polymer containing the monomer in at least a part thereof; and wherein a ratio of a weight of the additive to a weight of the metal particles is more than 0 and 0.150 or less.

### CROSS-REFERENCE TO RELATED APPLICATION

This application claims priority to Japanese Patent Application No. 2022-118337 filed on Jul. 26, 2022, incorporated herein by reference in its entirety.

### TECHNICAL FIELD

The present disclosure relates to a catalyst.

### BACKGROUND

Various studies have been made on catalysts for electrochemical oxygen reduction as disclosed in Patent Literature 1.
Patent Literature 1: International Publication No. 2019/221156

When, for the purpose of increasing catalyst performance, melamine (1,3,5-triazine-2,4,6-triamine) is added as an additive to a catalyst having an oxygen-reducing activity, it is bound to a binder having an acidic functional group, thereby inhibiting the water-retaining and proton-transporting functions of the binder. As a result, cell voltage in a low-humidity condition becomes lower than that of the case where no additive is added.

### SUMMARY

The present disclosure has been made in view of the above circumstances, and an object thereof is to provide a catalyst containing an organic nitrogen compound and configured to increase catalyst performance.

The catalyst of the present disclosure is a catalyst wherein the catalyst comprises metal particles having oxygen reduction activity, an additive and a binder; wherein the additive is at least one organic nitrogen compound; wherein the organic nitrogen compound is a monomer represented by the following general formula (1) or a polymer containing the monomer in at least a part thereof; and wherein a ratio of a weight of the additive to a weight of the metal particles is more than 0 and 0.150 or less:

### General Formula (1)

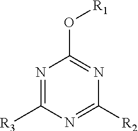

where each of R₁, R₂ and R₃ is a hydrogen atom, a halogen atom, or a functional group selected from the group consisting of the following functional groups: an amino group, a thiol group, a hydroxyl group, an alkylamino group having 1 to 10 carbon atoms, and an alkyl group having 1 to 10 carbon atoms, and each of the functional groups may have at least one selected from the group consisting of an oxygen atom, a sulfur atom, a nitrogen atom, a fluorine atom, a chlorine atom, a bromine atom, an iodine atom, and a hydrogen atom in a molecular chain thereof.

In the present disclosure, the additive may be cyanuric acid.

In the present disclosure, the additive may be a mixture of a first additive and a second additive; the first additive may be cyanuric acid; the second additive may be melamine; and a ratio of a weight of the second additive to a weight of the first additive may be 0.50 or more and 5.0 or less.

In the present disclosure, the ratio of the weight of the additive to the weight of the metal particles may be 0.010 or more and 0.150 or less.

In the present disclosure, the metal particles may be supported on a support; the metal particles may be platinum-cobalt alloy particles; the support may be acetylene black; and the binder may be a perfluorocarbon sulfonic acid polymer.

The present disclosure provides a catalyst containing an organic nitrogen compound and configured to increase catalyst performance.

### BRIEF DESCRIPTION OF THE DRAWINGS

In the accompanying drawings,

FIG. 1 is a graph showing cell voltage at low humidity (30% RH) when, in the catalysts of Examples 1 to 9 and Comparative Examples 1 to 6, the weight of the additive is changed with respect to the weight of the metal particles, and

FIG. 2 is a graph showing cell voltage at high humidity (80% RH) when, in the catalysts of Examples 1 to 9 and Comparative Examples 1 to 6, the weight of the additive is changed with respect to the weight of the metal particles.

### DETAILED DESCRIPTION

The catalyst of the present disclosure is a catalyst wherein the catalyst comprises metal particles having oxygen reduction activity, an additive and a binder; wherein the additive is at least one organic nitrogen compound; wherein the organic nitrogen compound is a monomer represented by the following general formula (1) or a polymer containing the monomer in at least a part thereof; and wherein a ratio of a weight of the additive to a weight of the metal particles is more than 0 and 0.150 or less.

When 1,3,5-triazine-2,4,6-triamine is used as an additive in a catalyst containing a binder, the cell voltage at low humidification is lower than when no additive is added due to the presence of the additive. Catalysts having high fuel cell or battery performance under both low humidification conditions and high humidification conditions are required.

In the present disclosure, by using an additive in which an amine functional group having a high basicity of melamine is substituted with a functional group having a low basicity such as a hydroxyl group, binding between the additive and the binder can be suppressed.

Further, in the present disclosure, an additive having an amine functional group such as melamine and an additive having a hydroxyl group such as cyanuric acid (1,3,5-triazine-2,4,6-triol) are simultaneously mixed to form a bond between the additives, and a compound called melamine cyanurate is preferentially and specifically formed, whereby the binding between the organic nitrogen compound and the binder can be suppressed. In addition, while the aqueous solubility of melamine is 3.5 g/L, melamine cyanurate is insoluble in water, increasing the stabilization inside the fuel cell or the battery.

According to the present disclosure, not only the voltage drop in the low humidification condition is suppressed, but also the voltage improvement effect in the high humidification condition is higher than that of melamine, and the catalytic activity can be improved regardless of the low humidification condition and the high humidification condition, and the cell voltage can be improved.

The catalyst of the present disclosure includes at least one metal particle having oxygen reduction activity, an additive, and a binder.

The additive is at least one organic nitrogen compound.

The at least one organic nitrogen compound is a monomer represented by the following formula (1) or a polymer containing the monomer at least in part.

General formula (1)

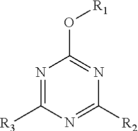

In the general formula (1), each of R₁, R₂ and R₃ is a hydrogen atom, a halogen atom, or a functional group selected from the group consisting of the following functional groups: an amino group, a thiol group, a hydroxyl group, an alkylamino group having 1 to 10 carbon atoms, and an alkyl group having 1 to 10 carbon atoms, and each of the functional groups may have at least one selected from the group consisting of an oxygen atom, a sulfur atom, a nitrogen atom, a fluorine atom, a chlorine atom, a bromine atom, an iodine atom, and a hydrogen atom in a molecular chain thereof.

In the general Formula (1), R₁, R₂ and R₃ may be a primary amine, a secondary amine, a tertiary amine, a quaternary ammonium cation, or a hydroxyl group, respectively.

The organic nitrogen compound may be a compound in which the nitrogen equivalent weight representing the dry weight per mole of nitrogen satisfies 20 to 270 g/eq or a compound in which the organic nitrogen compound satisfies 20 to 70 g/eq.

The nitrogen equivalent can be calculated from the following equation: In the case of a polymer, the nitrogen equivalent weight of the monomer is regarded as the nitrogen equivalent weight of the polymer.

Nitrogen equivalent(g/eq)=molecular weight(g/mol)/molecular weight of nitrogen material(mol_{N}/mol)

As the organic nitrogen compound, at least one organic nitrogen compound may be a compound represented by the general formula (1), and other organic nitrogen compounds may be used. Examples of the other organic nitrogen compound include the following compounds regardless of whether the compound is a compound represented by the general formula (1). It may be Melamine (nitrogen equivalent 21 g/eq), thiocyanuric acid (nitrogen equivalent 59 g/eq), cyanuric acid (nitrogen equivalent 34 g/eq), oleylamine (nitrogen equivalent 267 g/eq), tetradecylamine (nitrogen equivalent 213 g/eq), 2,4,6-Tris[bis(methoxymetyl)amino]-1,3,5-triazine (nitrogen-equivalent 65 g/eq), 6-(Dibutylamino)-1,3,5-triazine-2,4-dithiol (nitrogen-equivalent 68 g/eq), 2,4-Diamino-6-butylamino-1,3,5-triazine (nitrogen-equivalent 30 g/eq), 2,4,6-Tris(pentafluoroethyl)-1,3,5-triazine (nitrogen-equivalent 145 g/eq), a polymer comprising these monomers, and poly(melamine-co-formaldehyde)methylated (nitrogen-equivalent 20 to 40 g/eq), and Poly(melamine-co-formaldehyde)isobutylated (nitrogen-equivalent 20 to 40 g/eq) or the like. In addition, two or more kinds of the aforementioned additives may be included.

The additive may be at least one cyanuric acid-based material selected from the group consisting of cyanuric acid, a polymer partially containing cyanuric acid, and a polymer of cyanuric acid.

Isocyanuric acid as a tautomer of cyanuric acid, is also considered to be the same compound. The cyanuric acid and its tautomers may be stabilized by a halogen atom or the like.

The additive may be a mixture of the first additive and the second additive. The first additive may be at least one cyanuric acid-based material selected from the group consisting of cyanuric acid, a polymer partially containing cyanuric acid, and a polymer of cyanuric acid.

The second additive may be at least one melamine-based material selected from the group consisting of melamine, a polymer partially containing melamine, and a polymer of melamine. In particular, the first additive may be cyanuric acid, and the second additive may be melamine.

In the case of the polymer, since it is less likely to desorb after being adsorbed on the metal particle than in the case of the monomer, the adsorption stability is improved. The polymer may have a degree of polymerization ranging from 1 to 10000.

The metal particle may be any metal having oxygen reduction activity (oxygen reduction catalytic activity), and examples thereof include metal such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more of these metals may be used. The metal may be an oxide, a nitride, a sulfide, a phosphide, or the like.

The metal particle may be at least one selected from the group consisting of a platinum particle, a platinum alloy particle, and a composite particle containing platinum.

Metals other than platinum included in the platinum alloy and the composite particle containing platinum include metal such as ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and may contain two or more of these metals.

The elemental ratio of the metal other than platinum in the platinum alloy is not particularly limited, and may be 0.11 to 50 atm %.

The particle size of the metal particles is not particularly limited, and may be 1 to 100 nm.

In the present disclosure, the particle size of the particles is an average crystallite size measured by an X-ray diffraction method.

The particle size of the particles may be determined by measuring the particle size of 100 to 1000 particles by an electron microscope, and the average value thereof may be the average particle size of the particles. In the present disclosure, the particle size was measured by the above two methods.

The catalyst of the present disclosure may include a support.

The metal particle may be supported on a support.

The particle size of the primary particles of the carrier may be, for example, 5 to 500 nm.

The metal supporting ratio of the metal particles supported on the support is not particularly limited, and may be 1 to 60% or 18 to 48%.

The support may be carbon having conductivity, an oxide, or the like.

The carbon may be carbon black (such as acetylene black, Ketjen black, and furnace black), activated carbon, graphite, glassy carbon, graphite, graphene, carbon fiber, carbon nanotube, carbon nitride, sulfurized carbon, and phosphated carbon, or a mixture containing at least two of these.

The oxide may be titanium oxide, niobium oxide, tin oxide, tungsten oxide, molybdenum oxide, or a mixture containing at least two of them.

The binder is a polyelectrolyte having ion exchange groups.

The binder may be a polymer that exchanges ions, and the ion exchange group may be an acidic functional group. The acidic functional group may include a sulfonic acid, a phosphoric acid, and the like. The binder may be a perfluorocarbon sulfonic acid polymer, an anion exchange polymer, or a polymer based on polyether ether ketone, polybenzimidazole, and the like.

The equivalent weight of the binder per mole of the acidic functional group may be 600 g/mol or more and 1100 g/mol or less.

### [Ratio of Weight of Binder to Weight of Carrier]

In the catalyst of the present disclosure, the ratio of the weight of the binder to the weight of the support may be 0.50 or more and 0.85 or less.

The ratio of the weight of the binder to the weight of the carrier is defined as (binder weight)/(carrier weight).

### [Ratio of Total Weight of Additive to Weight of Metal Particles]

In the catalyst of the present disclosure, the ratio of the total weight of the additive to the weight of the metal particles may be greater than 0 and less than or equal to 0.150, and may be greater than or equal to 0.010 and less than or equal to 0.150.

The ratio of the weight of the additive to the weight of the metal particles is defined by (additive weight)/(metal particles weight).

When a mixture of the first additive and the second additive is used as the additive, the additive weight is the total weight of the first additive and the second additive.

### [Ratio of the Weight of the Second Additive to the Weight of the First Additive]

When a mixture of cyanuric acid (1,3,5-triazine-2,4,6-triol) or at least one kind of cyanuric acid-based material selected from the group consisting of a polymer containing cyanuric acid partially or a polymer of cyanuric acid, and melamine (1,3,5-triazine-2,4,6-triamine) or at least one kind of melamine-based material selected from the group consisting of a polymer containing melamine partially or a polymer of melamine is used as the second additive, the weight ratio of the second additive to the weight of the first additive may be 0 or more and 5.0 or less, and may be 0.50 or more and 5.0 or less. When a polymer containing cyanuric acid in part or a polymer of cyanuric acid and a polymer containing melamine in part or a polymer of melamine as a second additive are used as the first additive, the weight ratio in terms of monomer is used.

The ratio of the weight of the second additive to the weight of the first additive is defined as (second additive weight)/(first additive weight).

### [Method for Evaluating Weight of Additive]

Examples of the method for evaluating the weight of the additive included in the catalyst include a method of measuring the nitrogen content by CHN elemental spectrometry, a method of extracting the additive from the catalyst and directly measuring the additive, and the like.

### [Method for Evaluating Metal Particles Weight, Carrier Weight and Binder Weight]

Methods for evaluating the weight of the metal particles, the weight of the support, and the weight of the binder included in the catalyst of the present disclosure include thermogravimetric analysis (TG), high-frequency inductively coupled plasma-emission spectroscopy (ICP), and the like.

The catalyst of the present disclosure may be for a fuel cell or a metal-air cell. The catalyst of the present disclosure may be used for a cathode of a fuel cell, an anode of a fuel cell, or an air electrode of a metal-air cell. The fuel cell and the metal-air cell of the present disclosure may include a cathode including the catalyst of the present disclosure.

The shape of the catalyst of the present disclosure may be layered. That is, the catalyst of the present disclosure may be a catalyst layer. Examples of the catalyst layer forming method include the following methods.

### [Catalyst Ink Preparation Step]

First, a predetermined amount of a carrier (metal particle-supported carrier) carrying metal particles, a binder, an additive, and a solvent is charged into a container, and these are stirred using a stirrer to prepare a catalyst ink.

The solvent species is not particularly limited, and any liquid may be used, and may be water, an alcohol, a mixed solution of at least one alcohol and water, or the like.

Examples of the alcohol include methanol, diacetone alcohol, ethanol, 1-propanol, 2-propanol, tert-butyl alcohol, ethylene glycol, and propylene glycol.

Stirrers include ultrasonic homogenizers, jet mills, bead mills, ball mills, high share, fill mixes, and the like. The stirring conditions such as the stirring speed, the stirring time, and the number of revolutions are not particularly limited, and can be appropriately set.

Thereafter, a vacuum defoaming treatment may be performed. The time for standing is not limited, and may be arbitrarily set, and may be allowed to stand for one day. It is also possible to use it without standing. Further, the vacuum defoaming treatment may be performed again.

### [Catalyst Ink Coating Process]

The prepared catalyst ink is coated on a substrate, and the solvent is removed after the coating. For example, the catalyst ink is coated on a substrate such as polytetrafluoroethylene (PTFE), the catalyst ink after the coating is heated, and the solvents are dried and removed.

The coating method may be any method capable of uniformly coating the catalyst ink on the substrate, and examples thereof include a die coating method, a spin coating method, a screen printing method, a doctor blade method, a squeegee method, a spray coating method, and an applicator method. The heating rate and the heating time can be appropriately set depending on the solvent species and the like. Further, the removal rate may be increased by degassing simultaneously with warming.

The coating thickness may be 5 to 30 μm. Catalytic ink may be applied so that the platinum content of the coating film satisfies 0.1 to 0.6 mg cm⁻².

### EXAMPLES

### Example 1

Platinum-cobalt alloy particles (metal particles size: 3 to 4 nm), 1,3,5-triazine-2,4,6-triol (cyanuric acid, manufactured by Fujifilm Wako Pure Chemical Industries, Ltd.) as an additive, carbon (acetylene black) as a carrier, and perfluorocarbon sulfonic acid polymer (DE2020 manufactured by Chemours Co., Ltd.) as a binder were prepared, and a layer (catalyst layer) made of a catalyst containing these was formed by the following methods. The equivalent weight per mole of acidic functionality of the binder was 1100 g/mol. The weight of the binder with respect to the weight of the support in the catalyst was 0.85. The weight of the additive relative to the weight of the metal particles in the catalyst was 0.010.

### [Catalyst Layer Forming Method]

A carrier (metal particle-supported carrier, metal-supported ratio 50 wt %), a binder, an additive, a solvent, water, and diacetone alcohol were charged in a predetermined amount into a container, and these were stirred at a 300 rpm for a total of 4 hours using a bead mill to prepare a catalytic ink. The catalyst ink was vacuum defoamed and allowed to stand for 1 day. Thereafter, the catalyst ink was subjected to vacuum defoaming again. The prepared catalyst ink was coated on polytetrafluoroethylene (PTFE) as a base material by a die coating method, and the catalyst ink after the coating was heated, and the solvents were dried and removed to form a catalyst layer. The coating was applied so that the platinum content in the catalytic layers became 0.20 mg cm⁻².

### Examples 2 to 3

A layer (catalyst layer) composed of a catalyst was formed under the same conditions as in Example 1 except that the weight of the additive relative to the weight of the metal particles in the catalyst was changed as shown in Table 1.

### Examples 4 to 9, Comparative Example 2

1,3,5-triazine-2,4,6-triol (cyanuric acid, FUJIFILM Wako Pure Chemical Industries, Ltd.) were used as the first additive, and 1,3,5-triazine-2,4,6-triamine (melamine, FUJIFILM Wako Pure Chemical Industries, Ltd.) were used as the second additive. A layer (catalyst layer) composed of a catalyst was formed under the same conditions as in Example 1 except that the weight of the first additive relative to the weight of the metal particles in the catalyst, the weight of the second additive relative to the weight of the metal particles in the catalyst, the total weight of the additive relative to the weight of the metal particles in the catalyst, and the weight of the second additive relative to the weight of the first additive in the catalyst were set to the values shown in Tables 2 to 3.

### Comparative Example 1

A layer (catalyst layer) made of a catalyst was formed under the same conditions as in Example 1 except that no additive was used.

### Comparative Examples 3 to 6

1,3,5-triazine-2,4,6-triamine (Melamine, Fujifilm Wako Pure Chemical Industries, Ltd.) was used as an additive, and a layer (catalyst layer) made of a catalyst was formed under the same conditions as in Example 1 except that the weight of the additive relative to the weight of the metal particles in the catalyst was changed as shown in Table 4.

### Method for Producing Membrane-Electrode Gas Diffusion Layer Assembly

Catalyst layers prepared in Examples 1 to 9 and Comparative Examples 1 to 6 were prepared as a cathode catalyst layer, an electrolyte membrane (Nafion NR211) was prepared, and an anode catalyst layer containing TEC10E50E manufactured by Tanaka Precious Metal Industry was prepared as an anode catalyst. The membrane-electrode assembly was prepared by sandwiching the electrolyte membrane between the cathode catalyst layer and the anode catalyst layer, applying the temperature (130° C.) and the pressure (3 MPa), and thermocompression bonding the cathode catalyst layer, the electrolyte membrane, and the anode catalyst layer. Two gas diffusion layers (GDL 22BB manufactured by SGL) made of carbon fibers were prepared, and these were placed on both sides of the membrane-electrode assembly to prepare respective membrane-electrode gas diffusion layer assemblies of Examples 1 to 9 and Comparative Examples 1 to 6.

### [Real 1 cm² Cell Evaluation]

Cell evaluations were performed using respective membrane-electrode gas-diffusion-layer assemblies having 1 cm² electrode portions.

Current-voltage properties were evaluated under low humidification conditions (30% RH) and high humidification conditions (80% RH), respectively. The current-voltage properties were obtained by 20 mA/s, Anodic sweep for the sweep rate.

The cell temperature was 80° C., the pressure was 150 kPa ABS, the cathode gas species was Air, the cathode gas flow rate was 2.0 L/min, the anode gas species was hydrogen, and the anode gas flow rate was 1.0 L/min. The cell voltage (mV) in each of the low humidification condition (30% RH) and the high humidification condition (80% RH) was calculated from the current-voltage property. Results are set forth in Tables 1 to 4.

As an evaluation criterion for cell voltage under low humidity conditions (30% RH), a case where the cell voltage is equal to or greater than 773 mV is set to 1 (Excellent), a case where the cell voltage is equal to or greater than 703 and less than 773 mV is set to 2 (Good), a case where the cell voltage is equal to or greater than 634 mV and less than 703 mV is set to 3 (Average), and a case where the cell voltage is less than 634 mV is set to 4 (Poor).

As an evaluation criterion for cell voltage under high humidification conditions (80% RH), a case where the cell voltage is equal to or higher than 846 mV is set to 1 (Excellent), a case where the cell voltage is equal to or higher than 843 mV and lower than 846 mV is set to 2 (Good), a case where the cell voltage is equal to or higher than 836 mV and lower than 843 mV is set to 3 (Average), and a case where the cell voltage is less than 836 mV is set to 4 (Poor).

TABLE 1

| | Example 1 | Example 2 | Example 3 |
|---|---|---|---|
| First additive | 1,3,5-triazine- | 1,3,5-triazine- | 1,3,5-triazine- |
| | 2,4,6-triol | 2,4,6-triol | 2,4,6-triol |
| Weight of the first additive relative to the | 0.010 | 0.050 | 0.100 |
| weight of the metal particles (—) | | | |
| Second additive | — | — | — |
| Weight of the second additive relative to the | 0.000 | 0.000 | 0.00 |
| weight of the metal particles (—) | | | |
| Weight ratio of the second additive to the | 0.00 | 0.00 | 0.00 |
| first additive | | | |
| Total additive weight (—) relative to the | 0.010 | 0.050 | 0.100 |
| metal particles weight | | | |
| Cell Voltage (mV) in 30% RH | 759 | 763 | 756 |
| Evaluating Voltage-Improvement during | 2 | 2 | 2 |
| 30% RH | | | |
| Cell Voltage (mV) in 80% RH | 846 | 849 | 851 |
| Evaluating Voltage-Improvement during | 1 | 1 | 1 |
| 80% RH | | | |

TABLE 2

| | Example 4 | Example 5 | Example 6 | Example 7 |
|---|---|---|---|---|
| First additive | 1,3,5- | 1,3,5- | 1,3,5- | 1,3,5- |
| | triazine- | triazine- | triazine- | triazine- |
| | 2,4,6-triol | 2,4,6-triol | 2,4,6-triol | 2,4,6-triol |
| Weight of the first additive relative to | 0.010 | 0.025 | 0.050 | 0.010 |
| the weight of the metal particles (—) | | | | |
| Second additive | 1,3,5- | 1,3,5- | 1,3,5- | 1,3,5- |
| | triazine- | triazine- | triazine- | triazine- |
| | 2,4,6- | 2,4,6- | 2,4,6- | 2,4,6- |
| | triamine | triamine | triamine | triamine |
| Weight of the second additive relative | 0.010 | 0.025 | 0.050 | 0.050 |
| to the weight of the metal particles (—) | | | | |
| Weight ratio of the second additive to | 1.0 | 1.0 | 1.0 | 5.0 |
| the first additive | | | | |
| Total additive weight (—) relative to the | 0.020 | 0.050 | 0.100 | 0.060 |
| metal particles weight | | | | |
| Cell Voltage at 30% RH (mV) | 764 | 753 | 714 | 732 |
| Evaluating Voltage-Improvement | 2 | 2 | 2 | 2 |
| during 30% RH | | | | |
| Cell Voltage at 80% RH (mV) | 851 | 849 | 849 | 849 |
| Evaluating Voltage-Improvement | 1 | 1 | 1 | 1 |
| during 80% RH | | | | |

TABLE 3

| | | | Comparative | Comparative |
|---|---|---|---|---|
| | Example 8 | Example 9 | Example 1 | Example 2 |
| First additive | 1,3,5-triazine- | 1,3,5-triazine- | — | 1,3,5-triazine- |
| | 2,4,6-triol | 2,4,6-triol | | 2,4,6-triol |
| Weight of the first additive relative to | 0.030 | 0.100 | 0.000 | 0.100 |
| the weight of the metal particles (—) | | | | |
| Second additive | 1,3,5-triazine- | 1,3,5-triazine- | — | 1,3,5-triazine- |
| | 2,4,6-triamine | 2,4,6-triamine | | 2,4,6-triamine |
| Weight of the second additive relative | 0.050 | 0.050 | 0.000 | 0.100 |
| to the weight of the metal particles (—) | | | | |
| Weight ratio of the second additive to | 1.7 | 0.50 | — | 1.0 |
| the first additive | | | | |
| Total additive weight (—) relative to the | 0.080 | 0.150 | 0.000 | 0.200 |
| metal particles weight | | | | |
| Cell Voltage at 30% RH (mV) | 719 | 703 | 773 | 680 |
| Evaluating Voltage-Improvement | 2 | 2 | 1 | 3 |
| during 30% RH | | | | |
| Cell Voltage at 80% RH (mV) | 849 | 848 | 835 | 837 |
| Evaluating Voltage-Improvement | 1 | 1 | 4 | 3 |
| during 80% RH | | | | |

TABLE 4

| | Comparative | Comparative | Comparative | Comparative |
|---|---|---|---|---|
| | Example 3 | Example 4 | Example 5 | Example 6 |
| First additive | — | — | — | — |
| Weight of the first additive relative to | 0.000 | 0.000 | 0.000 | 0.000 |
| the weight of metal particles (—) | | | | |
| Second additive | 1,3,5- | 1,3,5- | 1,3,5- | 1,3,5- |
| | triazine- | triazine- | triazine- | triazine- |
| | 2,4,6- | 2,4,6- | 2,4,6- | 2,4,6- |
| | triamine | triamine | triamine | triamine |
| Weight of the second additive relative | 0.010 | 0.050 | 0.100 | 0.150 |
| to the weight of the metal particles (—) | | | | |
| Weight ratio of the second additive to | — | — | — | — |
| the first additive | | | | |
| Total additive weight (—) relative to the | 0.010 | 0.050 | 0.100 | 0.150 |
| metal particles weight | | | | |
| Cell Voltage at 30% RH (mV) | 753 | 633 | 570 | 474 |
| Evaluating Voltage-Improvement | 2 | 4 | 4 | 4 |
| during 30% RH | | | | |
| Cell Voltage at 80% RH (mV) | 842 | 846 | 846 | 831 |
| Evaluating Voltage-Improvement | 3 | 1 | 1 | 4 |
| during 80% RH | | | | |

### [Evaluation Results]

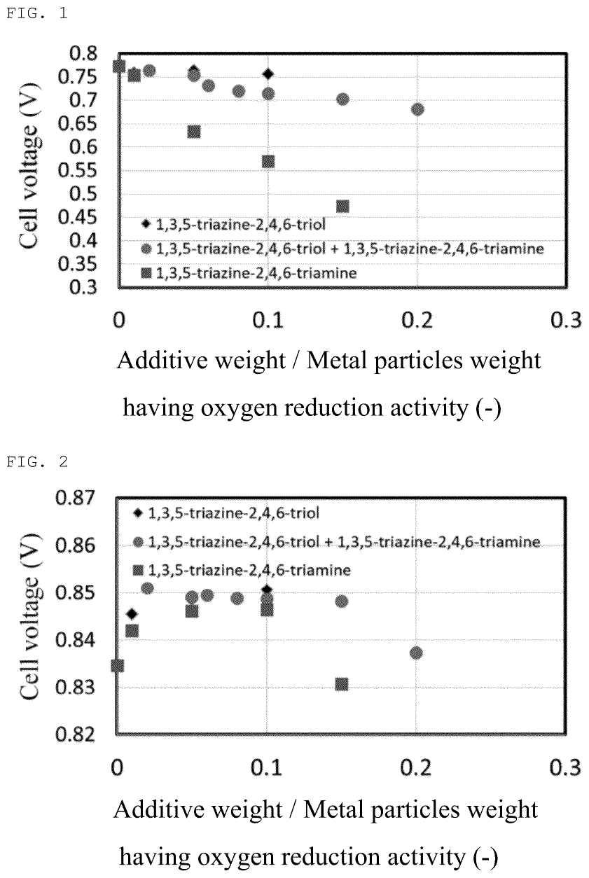

FIG. 1 is a graph showing cell voltage at low humidity (30% RH) when, in the catalysts of Examples 1 to 9 and Comparative Examples 1 to 6, the weight of the additive is changed with respect to the weight of the metal particles.

FIG. 2 is a graph showing cell voltage at high humidity (80% RH) when, in the catalysts of Examples 1 to 9 and Comparative Examples 1 to 6, the weight of the additive is changed with respect to the weight of the metal particles.

As shown in FIGS. 1 to 2 and Tables 1 to 4, it can be seen that the cells using the catalysts of Examples 1 to 9 have higher cell voltages in the low humidification condition (30% RH) and the high humidification condition (80% RH) than the cells using the catalysts of Comparative Examples 2 to 6.

1. A catalyst,
wherein the catalyst comprises metal particles having oxygen reduction activity, an additive and a binder;
wherein the additive is at least one organic nitrogen compound;
wherein the organic nitrogen compound is a monomer represented by the following general formula (1) or a polymer containing the monomer in at least a part thereof; and
wherein a ratio of a weight of the additive to a weight of the metal particles is more than 0 and 0.150 or less:
General Formula (1) 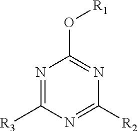
where each of R₁, R₂ and R₃ is a hydrogen atom, a halogen atom, or a functional group selected from the group consisting of the following functional groups: an amino group, a thiol group, a hydroxyl group, an alkylamino group having 1 to 10 carbon atoms, and an alkyl group having 1 to 10 carbon atoms, and each of the functional groups may have at least one selected from the group consisting of an oxygen atom, a sulfur atom, a nitrogen atom, a fluorine atom, a chlorine atom, a bromine atom, an iodine atom, and a hydrogen atom in a molecular chain thereof.

2. The catalyst according to claim 1, wherein the additive is cyanuric acid.

3. The catalyst according to claim 1,
wherein the additive is a mixture of a first additive and a second additive;
wherein the first additive is cyanuric acid;
wherein the second additive is melamine; and
wherein a ratio of a weight of the second additive to a weight of the first additive is 0.50 or more and 5.0 or less.

4. The catalyst according to claim 1, wherein the ratio of the weight of the additive to the weight of the metal particles is 0.010 or more and 0.150 or less.

5. The catalyst according to claim 1,
wherein the metal particles are supported on a support;
wherein the metal particles are platinum-cobalt alloy particles;
wherein the support is acetylene black; and
wherein the binder is a perfluorocarbon sulfonic acid polymer.
